(19) United States
(12) Patent Application Publication
(10) Pub. No.: US 2013/0192607 A1
(43) Pub. Date: Aug. 1, 2013

(54) CONNECTION DEVICE FOR SURGICAL EQUIPMENT

(71) Applicant: Jürgen Brecht, Graben-Neudorf (DE)

(72) Inventor: Jürgen Brecht, Graben-Neudorf (DE)

(21) Appl. No.: 13/362,125

(22) Filed: Jan. 31, 2012

(51) Int. Cl. A61G 15/00

(52) U.S. Cl. 128/845

(57) ABSTRACT

A connection device for an adjustable connection of a medical device, preferably a head restraint, to an accessory of a stationary device, preferably an operating table, is provided. The medical device can be connected to one end, and the stationary device can be connected with the other end of the connection device, and this connection device has at least two holding arms (10a, 10b, 10c) connected via a ball and socket joint, with the first holding arm (10a) comprising a joint socket (110a), the second holding arm (10b) a ball joint (12a) matched thereto. The ball and socket joint can be fixed in a desired angular position by a detachable clamping device. Here, the ball joint (12a) and the holding arm (10b) supporting it are inserted on a common connecting cone (25, 25c, 25d, 25e) and are clamped thereto in the axial and radial direction.

### BACKGROUND

The invention relates to a connection device for an adjustable connection of medical equipment, preferably a patient head restraint, with an attachment for a stationary device, preferably an operating table, with the medical device being connectable with one end and the stationary equipment with the other end of the connection device. The connection device comprises at least two holding arms connected via a ball and socket joint, with the first holding arm comprising a joint socket, the second holding arm comprising a matching ball joint, and the ball and socket joint can be fixed in a desired angular position by way of a detachable clamping device.

Such connection devices can be used to hold body parts, particularly the head of the patient, or medical devices, such as endoscopes, hooks, or the like in a defined position during surgery. In order for the desired position of the auxiliary device or the body part to be precisely maintained during the application, the connection device is articulate in all spatial directions and upon reaching the desired position it can be fixed.

The present invention is based on DE 10 2007 035 922, which is hereby incorporated by reference in its entirety. This connection device of prior art comprises a particular clamping device for the ball and socket joint, which operates with a hydraulic transmission and thus creates high clamping forces. It allows a very stable and secure fastening of the body part, at which the surgical operation shall be performed. This fixation is of particular importance during surgery because any failure of the clamping can result in severe consequences, potentially leading to serious injuries of the patent.

Experiments of the applicant with the connection device of prior art have now shown that other components subject to load transfer are in need of improvement with regards to their stability and reliability.

Here, the invention is based on the acknowledgement that due to the improved clamping effect of the ball and socket joint other components are in danger by bending and torsion forces developing here and thus require a more stable anchoring than in the past.

### SUMMARY

The present invention is therefore based on the objective of improving the connection device of prior art with regards to its stiffness in the clamped state and its reliability.

This objective is attained according to the invention in that the head of the ball joint and the support arm carrying it extend on a common connecting cone and are axially and radially clamped thereon. Thus, instead of the previous screwed connection, which is primarily in danger due to torsion forces developing during operation, a clamped connection with the connecting cone is used. The fastening of the ball joint to its fastening arm is therefore considerably more stable and allows the transfer of higher bending and torsion forces than in the past.

This connecting cone can be embodied as a solid element and be clamped by nuts or bolts, arranged at its two ends, in individual holding arms supporting it and/or in its ball joint.

A particularly beneficial further development of the invention comprises that the connecting cone is embodied as a conical sheath, which is axially traversed by a clamping bolt and thus the sheath is clamped in the ball joint and/or its holding arm and simultaneously connects the ball joint with the holding arm. This results in an essential advantage, namely the redundancy of the connection: when for example the conical sheath breaks, the system is still held together by the clamping bolt, however when the clamping bolt fails the conical sheath is capable to compensate the loads alone. In both cases, the damages are discernible from the outside: In case of a broken conical sheath the bolt will slowly give due to the torque, when the bolt is broken at least a portion thereof will fall out of the ball joint.

Based on this redundancy the safety of the described connection doubles, which is of eminent importance in the above-described surgical applications.

The conical clamping connection can either be provided only at the ball joint or only at its holding arm. However, it is particularly beneficial when both at the ball joint as well as its holding arm conical contact surfaces are provided, because then the fastening at both parts becomes more stable and reliable.

A further development of the invention comprises that the connecting cone is embodied as a dual cone such that its diameter and/or in case of a sheath-like embodiment its wall thickness tapers towards both ends. This way, a conical connection can be created both at the head of the ball joint as well as the second holding arm carrying it.

Beneficially, the connecting cone is inserted in a conical recess of the head of the ball joint and/or the holding arm, sized such that an axial and radial pre-stressing can be realized in the conical recess(es). In other words, the diameter and the length of the conical recess(es) lead during the tightening of the screwed connection to a relative axial motion, which causes a clamping effect exclusively dependent on the tightening moment and the material strength.

In order to ensure a defined pre-stressing of the connecting cone in its holding arm and/or its head of the ball joint, the screw connection can be made using torque wrenches. Alternatively it is also possible to limit the relative axial motion of the conical contact surfaces by way of stops at the connecting cone and/or at the ball joint and/or at the holding arm by positioning these stops such that upon reaching the stop a sufficient relative axial motion has been performed ensuring a defined radial pre-stressing.

In order to facilitate the relative axial motion of the connecting cone it is recommended that the connecting cone is polished at its conical exterior and that even after an axial pre-stressing of the sheath still a gap remains between the head of the ball joint and the second holding arm carrying it.

The conical angle ranges beneficially from 2° to 3°.

The screw connection of the solidly embodied connecting cone beneficially occurs at both ends by way of nuts or bolts. However, in a sheath-like embodiment of the connecting cone beneficially operation occurs via a clamping bolt axially crossing it, which is beneficially screwed with its end at the side of the threads to the ball joint, if applicable with a threaded sheath being interposed, which from the outside can be inserted into a recess of the ball joint. Accordingly, the head of the clamping bolt is arranged in the area of the holding arm, particularly in a counter-sunk fashion.

In order to facilitate the assembly of the connection device, particularly that of subsequent holding arms, it is finally beneficial for the screwed/tightened connection of the connecting cone to be detachable from both of its ends.

A particularly beneficial further development of the invention comprises that the connecting cone is connected torque-proof at least at one end in a form-fitting fashion via its holding arm and/or its ball joint. Here, it is essential that this form-fitting connection allows the above-described relative axial motion of the connecting cone, however remains torque-proof in the circumferential direction.

One skilled in the art knows a multitude of options for a constructive embodiment of such a form-fitting connection using axial projections, which engage appropriate recesses.

Finally, one further development of the invention comprises that the various holding arms are not equally sized, but that they are dimensioned with different strengths according to their individually loaded momentum. For example, the holding arm mounted at a stationary device must carry a considerably higher load and accordingly be sized appropriately more stable than a fastening arm located closer to the medical device, which consequently may be sized considerably weaker. This gradual sizing of the fastening arms can also be realized according to the invention independent from the connecting cone.

### BRIEF DESCRIPTION OF THE DRAWINGS

Additional details and features of the invention are discernible from the following description of an exemplary embodiment and from the drawing, in which:

FIG. 1 is a perspective view of the connection element with three holding arms,

FIG. 2 is an enlarged longitudinal cross-section through a holding arm with an articulated connection to a downwards connecting holding arm to a sheath-shaped connecting cone,

FIG. 3 is a view of a connecting cone with projections at their ends,

FIG. 4 is a view of a solid connecting cone with clamping screws at the ends, and

FIG. 5 is a view of a solid connecting cone with clamping nuts at the ends.

### DETAILED DESCRIPTION FO THE PREFERRED EMBODIMENTS

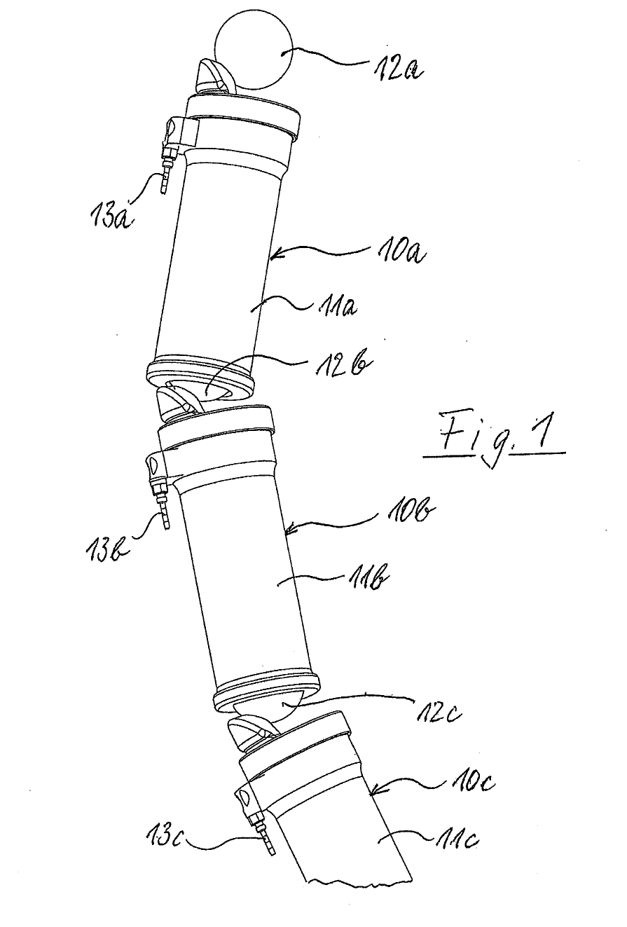

FIG. 1 shows the connection device in a schematic illustration using the example of three holding arms 10a, 10b, and 10c, each of which being connected to each other in an articulate fashion. One end of the connection device can be fastened at an operating table, for example, while the other end carries for example a head restraint, not shown, for a neurosurgical operation.

Each holding arm 10a, 10b, 10c comprises an approximately cylindrical housing 11a, 11b, 11c, which carries at its one end a ball joint 12a, 12b, and/or 12c.

The ball joints are each inserted in receivers of the ball joints of the adjacent holding arm and are supported here in a manner rotational in all directions, which however can be fixed by a clamping device, when necessary. This clamping device operates hydraulically; for this purpose each holding arm comprises a hydraulic connection 13a, 13b, and/or 13c, via which the above-mentioned clamping and/or the release of said clamping can be realized. The control of the hydraulic flow usually occurs via a common or individual foot control connected to the respective holding arms.

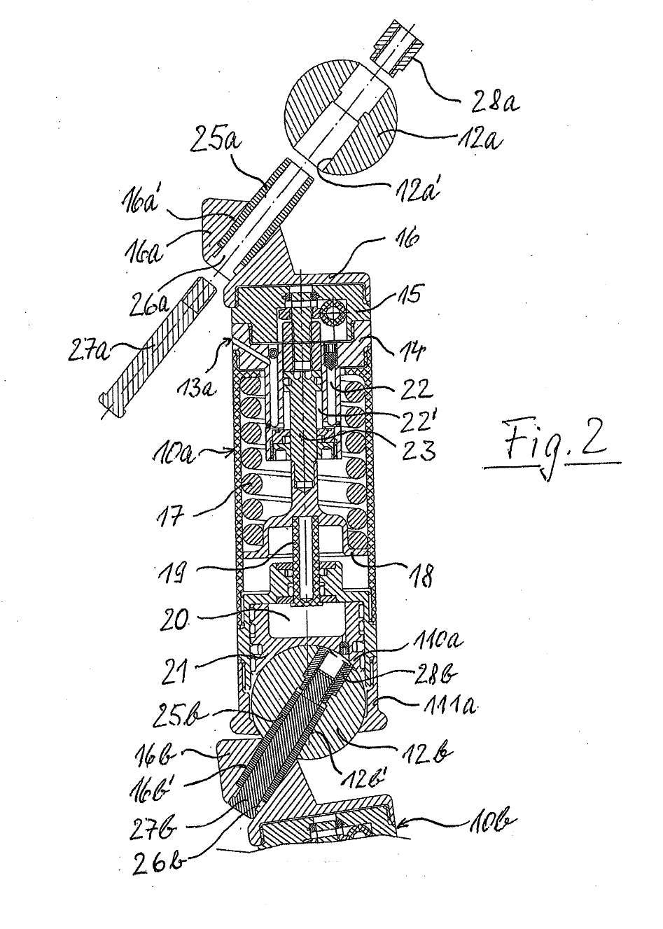

The axial cross-section in FIG. 2 shows the design of the clamping device using the example of the holding arm 10a. It is discernible that the holding arm comprises a cylindrical housing 11a, which shows at its upper end a ring 14 with a hydraulic connection 13a and additionally an intermediate ring 15, which is closed at its upper end by a lid 16. At this lid 16 the head of the ball joint 12 is fastened, which is discussed in greater detail in the following.

The bottom end of the holding arm exhibits a receiver of the ball joint 110a with a ring 111a covering the ball joint 12b and a joint socket 21 cooperating with the inside of the ball joint 12b, which is supported in the holding arm 10a in an axially displaceable fashion and serves to clamp the ball joint.

In the interior of the cylindrical housing 11a a pre-stressed pressure spring 17 is arranged. It is pre-stressed between the upper end of the housing 11a on the one side and a piston 18, so that the latter is subjected to a force downwards. This force is transferred to an operating element 19 so that the latter is urged to penetrate into an interior chamber 20 filled with hydraulic fluid. This leads to an increased pressure in the above-mentioned interior chamber 20. This increased pressure acts upon the joint socket 21 arranged underneath thereof. Due to the fact that this joint socket is impinged with a considerably larger area by the hydraulic pressure in the interior chamber 20 than the operating element 19, a strong transmission occurs of the force originally generated by the spring 17 and thus to a strong clamping of the ball joint. For this purpose, the stroke of the operating element 19 is considerably larger than the stroke of the joint socket 21, which is not of critical importance, though.

In order to loosen the clamping device hydraulic fluid is inserted via the hydraulic connection 13a into the annular chamber 22 of the ring 14. This hydraulic fluid flows further into an annular chamber 22′ and pushes a central hydraulic piston 23 against the pressure of the spring 17 upwards, namely approximately to the position shown in the drawing, because the drawing shows the clamping device in the loosened position. Accordingly, the operating element 19 is also pulled upwards, into the position according to the drawing, so that the above-described pressure in the interior chamber 20 is compensated by the immersion of the operating element 19, and the joint socket 21 is no longer pressed against the head 12b of the ball joint.

For the other details reference is made to DE 10 2007 035 922 in its entirety, where the clamping device is described in greater details.

For the present application the fastening of the ball joint 12b at its holding arm 10a is essential. This fastening is shown at the upper end of the holding arm 10 in an axially exploded, disassembled state, in the downwards following holding arm 10b however in the finished assembled and pre-stressed state.

In reference to the ball joint 12a supported by the holding arm 10a it is discernible that the holding arm 10a at its lid 16, similar to prior art, comprises a projection 16a. This projection, different from prior art, shows no cylindrical but an at least partially conical bore 16a′ such that the diameter of said bore tapers from the top towards the bottom.

Similarly, the ball joint 12a also shows an at least partially conical bore 12a′, with its diameter tapering towards the top.

Corresponding to these two axially following conical bores with opposite tapering, a connecting cone is arranged inside in the form of a conical sheath 25a, projecting respectively about half way into both conical bores. It comprises two opposite cones, with their exterior diameter therefore tapering towards the two ends of the sheath, matching the conical bores 12a′ and 16a′.

The assembly of the ball joint 12a at its holding arm 10a is performed as follows: Firstly the two conical bores 10a′ and 16a′ are pushed onto the conical sheath 25a, beginning at the ends of the sheath, and pushed together as far as possible. Then a clamping bolt 27a is pushed into the penetrating bore 26a, which completely crosses both the projection 16a of the holding arm 10a as well as the sheath 25 and the ball joint 12a. By the subsequent tightening of the clamping bolt 27a, the projection 16a is pre-stressed on the bottom cone, and the ball joint 12a on the upper cone of the sheath 25a.

In the exemplary embodiment the bolt head of the clamping bolt 27a is supported on the projection 16a and the end of the clamping bolt 27a at the threaded side is positioned in the ball joint 12a with a threaded sheath 26a being interposed. Of course, it is also possible instead to directly insert the receiving thread for the clamping bolt 27a into the ball joint 12a. Additionally it would be possible to provide the clamping bolt 27a in the opposite direction, thus with the bolt head in the ball joint.

The finished screwed-in condition is shown at the bottom of FIG. 2, with the same reference characters being used as at the top of FIG. 2, however marked with the letters b instead of a. Here, the two conical bores 12b′ and 16b′ are each clamped on the cone of the sheath 25b respectively allocated thereto. In order for this tightening to occur equally at both conical ends and the relative motions required therefore between the sheath and the parts surrounding them not being restricted the conical bores should be sized such that after the tightening of the clamping bolt 27b, preferably via a torque wrench, a small clearance gap remains between the ball joint 12a and the projection 16b.

Here, beneficially the option is provided to limit the relative axial motions between the connecting cone and the two parts resting thereupon by way of stops. These stops are to be positioned such that upon reaching them the desired radial pre-stressing is ensured.

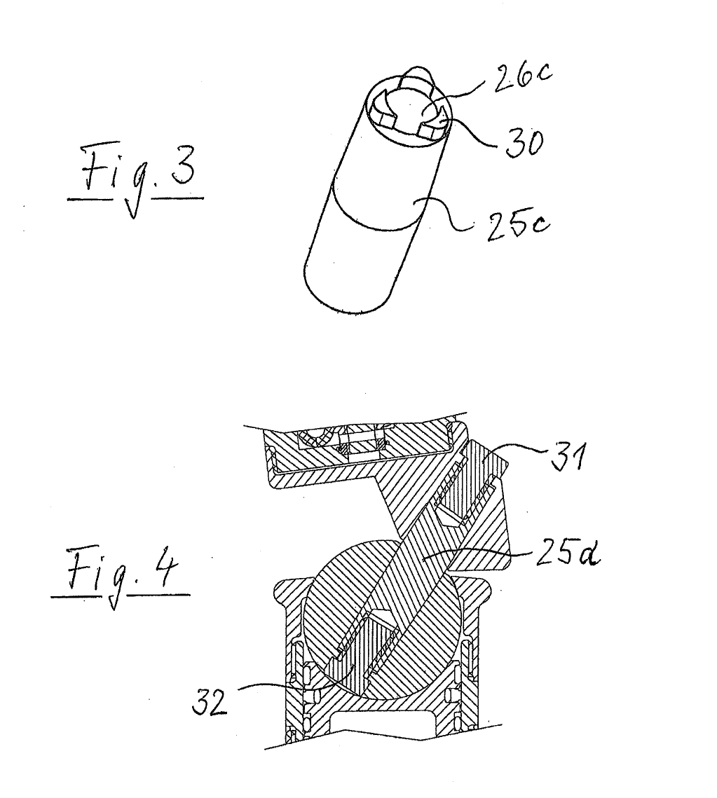

FIG. 3 shows a conical sheath 25c, which is characterized such that it has at least at one end axially protruding projections 30. In the exemplary embodiment, there are three projections distributed evenly over the circumference, which abut flush at the inside of the bore 26c of the sheath, while at the outside forming the rounded edges of a virtual triangle. This virtual triangle is located as a counter-bearing in the ball joint as well as the holding arm supporting it such that here a respectively form-fitting, torque-proof connection develops.

Of course, the projections and the respective counter-bearings may also show arbitrarily other shapes.

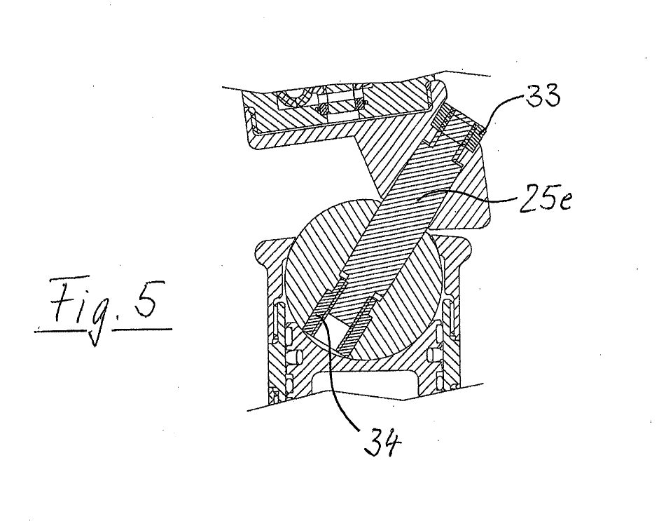

FIGS. 4 and 5 show solid connecting cones 25d and 25e. They are not penetrated by a clamping bold piercing them, but are clamped via bolts or nuts in their connecting parts.

For this purpose, FIG. 4 shows the connecting cone 25d with threaded bores at both ends, in which one clamping bolt 31 and/or 32 each is screwed in, in order to create the desired pre-stressing of the ball joint and/or its holding arm on the connecting cone.

Contrary thereto, in FIG. 5 the connecting cone 25e is provided at both ends with a threaded pin with a reducing diameter and nuts 33 and/or 34 are screwed onto this threaded pin in order to implement the desired pre-stressing.

Summarizing, the advantage of the present invention comprises that by the dual pre-stressing of the cones at the two parts of the ball and socket joint to be connected to each other an extremely stable and reliable connection is created and that the combination of the conical sheath with the clamping bolt creates a redundant connection with a high safety reserve.

1. A connection device for adjustable connection of a medical device with an accessory of a stationary device, with the medical device being adapted to be connected to one end and the stationary device being adapted to be connected to the other end of the connecting device, the connecting device comprising at least two holding arms (10a, 10b, 10c) connected via a ball and socket joint, in which the first holding arm (10a) comprises a joint socket (110a), the second holding arm (10b) comprises a ball joint (12b) matching thereto, and the ball and socket joint can be fixed in a desired angular position by a detachable clamping device, the ball joint (12a) and the holding arm (10b) supporting it being inserted on a common connecting cone (25b, 25c, 25d, 25e) and being axially and radially clamped thereto.

2. The connection device according to claim 1, wherein the connecting cone is a solid cone (25c) and is clamped at both ends via nuts (31, 32) or bolts (33, 34).

3. The connection device according to claim 1, wherein the connecting cone is embodied as a conical sheath (25b) axially traversed by a clamping bolt (27b).

4. The connection device according to claim 1, wherein the connecting cone (25b, 25c, 25d, 25e) has an exterior configured as a dual cone such that a diameter tapers towards both ends.

5. The connection device according to claim 1, wherein the connecting cone (25b, 25c, 25d, 25e) is inserted in a conical socket (12b′ and/or 16b′) of at least one of the ball joint (12a) or the holding arm (10b), that is sized such that an axial clamping of the cone can be realized in the conical socket(s) (12b′ and/or 16b′).

6. The connection device according to claim 1, wherein even after the axial clamping of the connecting cone, a clearance gap remains between the ball joint (12a) and the holding arm (10b) supporting the ball joint.

7. The connection device according to claim 1, wherein the connecting cone (25b, 25c, 25d, 25e) has polished conical exterior surfaces.

8. The connection device according to claim 3, wherein the end of the clamping bolt (27b) at the threaded side is screwed into the ball joint (12a).

9. The connection device according to claim 3, wherein the end of the clamping bolt (27b) at the threaded side is screwed into an interposed threaded sheath (28b) in the ball joint (12a).

10. The connection device according to claim 1, wherein the clamping bolt (27b) is arranged in a completely penetrating bore (26b).

11. The connection element according to claim 3, wherein a head of the clamping bolt (27b) is arranged in a projection (16b) of the holding arm (10b) supporting it.

12. The connection device according to claim 1, wherein the connecting cone (25c) is connected in a torque-proof fashion at least at one end by a form-fitting connection with at least one of the holding arm (10b) or the ball joint (12a).

13. The connection element according to claim 1, wherein the holding arms (10a, 10b, 10c) are sized with different thicknesses according to individual stress moments adapted to act thereon.
